(19) United States
(12) Patent Application Publication
(10) Pub. No.: US 2009/0088496 A1
(43) Pub. Date: Apr. 2, 2009

(54) METHOD FOR PRODUCING RUBBER-FILLER COMPOSITE

(75) Inventors: Takashi Miyasaka, Osaka (JP); Takashi Yuri, Osaka (JP); Hiroaki Narita, Osaka (JP); Hirofumi Hayashi, Osaka (JP)

Correspondence Address: FISH & RICHARDSON P.C., P.O. BOX 1022, MINNEAPOLIS, MN, 55440-1022, US

(73) Assignee: Toyo Tire & Rubber Co., Ltd., Osaka (JP)

(21) Appl. No.: 12/210,273

(22) Filed: Sep. 15, 2008

(30) Foreign Application Priority Data
Oct. 1, 2007 (JP) 2007-257475

(51) Int. Cl. C08J 3/22

(52) U.S. Cl. 523/334

(57) ABSTRACT

A rubber-filler composite exhibiting low heat build-up, fatigue resistance and heat aging resistance equal to those of a concentrated natural rubber latex, despite using a field latex of a natural rubber and omitting a concentration step is disclosed. The rubber-filler composite is obtained by jetting a field latex of a natural rubber in a form of a high-speed flow having a flow rate of 500 m/sec or more into a mixing chamber while supplying a filler slurry containing a filler to the mixing chamber, thereby separating and removing protein in the field latex from a rubber component and at the same time, mixing the field latex and the filler slurry.

### CROSS-REFERENCE TO RELATED APPLICATIONS

This application is based upon and claims the benefit of priority from the prior Japanese Patent Application No. 2007-257475, filed on Oct. 1, 2007; the entire contents of which are incorporated herein by reference.

### BACKGROUND

The present invention relates to a method for producing a rubber-filler composite which is a composite of a rubber and a filler. More particularly, it relates to a method for producing a rubber-filler composite which is used as a masterbatch, comprising a natural rubber and a filler such as carbon black or silica dispersed therein.

For the purpose of reinforcement or the like, a filler such as carbon black is compounded with a rubber composition used in tires or the like. Conventionally, mixing of such a filler and a rubber has employed a method of adding a filler in a form of a powder to a rubber and then kneading those, called dry mixing. However, there is the limit to uniformly finely disperse the filler to a rubber by this method.

In view of the above, it is recently proposed that a rubber-filler composite called a wet masterbatch is prepared by mixing a filler slurry comprising a filler such as carbon black or silica previously dispersed in water, and a rubber latex, and this composite is compounded with a rubber composition, thereby improving low heat build-up, abrasion resistance on rough road, and the like (see WO 97/36724, JP-A-2006-152117, US 2003/88006 A1 and US 2004/109944 A1).

For example, WO 97/36724 proposes that a filler slurry and a rubber latex are supplied as a jet flow under high pressure to a mixing zone for mixing the filler slurry and the rubber latex, thereby mixing those. This can improve low heat build-up and abrasion resistance on rough road as compared with dry mixing. However, in this method, a flow rate in supplying the rubber latex to the mixing zone is 100 to 800 feet per second, that is, the maximum flow rate is 244 m/sec. Thus, the flow rate is insufficient, and it is insufficient to bring out the maximum performance as a rubber-filler composite. Furthermore, WO 97/36724 does not disclose that protein in a field latex can be removed by jetting a field latex of a natural rubber in a form of a high-speed flow having a given flow rate or more.

On the other hand, a field latex of a natural rubber contains non-rubber components such as protein, and those components adversely affect low heat build-up, fatigue resistance, heat aging resistance and the like. For this reason, a concentrated natural rubber latex obtained by concentrating a field latex is provided. JP-A-2006-213750 and US 2006/128879 A1 disclose that the field latex of a natural rubber is deproteinized by a centrifugal concentration method. However, in this case, in producing a rubber-filler composite, a concentration step of a field latex is necessary as a pre-treatment for mixing a filler slurry and a rubber latex.

### SUMMARY

The present invention has been made in view of the above circumstances, and has an object to provide a method for producing a rubber-filler composite that can obtain low heat build-up, fatigue resistance and heat aging resistance substantially equal to those of a concentrated natural rubber latex while omitting a concentration step by mixing a field latex of a natural rubber while high-speed jetting, with a filler slurry, thereby removing protein in the field latex.

The method for producing a rubber-filler composite according to the present invention comprises jetting a field latex of a natural rubber in a form of a high-speed flow having a flow rate of 500 m/sec or more into a mixing chamber while supplying a filler slurry containing a filler to the mixing chamber, thereby separating and removing protein in the field latex from a rubber component and at the same time, mixing the field latex and the filler slurry.

In the invention above, more preferably the filler is finely dispersed in the slurry by supplying the filler slurry at a flow rate of 300 m/sec or more to a dispersion treating chamber before mixing the filler slurry with the field latex.

According to the present invention, protein in the field latex can be separated and removed from a rubber component by jetting the field latex of a natural rubber in a form of a high-speed flow having a flow rate of 500 m/sec or more. As a result, low heat build-up, fatigue resistance and heat aging resistance substantially equal to those of a concentrated natural rubber latex can be obtained. Furthermore, because the field latex is mixed with a filler slurry while jetting the field latex at high speed as above, a concentration step can be omitted. This reduces the number of processing steps, resulting in reduction in cost.

In the present invention, the coagulated fillers can effectively be crushed by treating the filler slurry with a high-speed flow equal to or more than sonic speed having a flow rate of 300 m/sec or more before mixing the filler slurry with a field latex. The filler can finely be dispersed uniformly in the rubber component by mixing the filler slurry thus dispersion treated, with a field latex. As a result, when the rubber-filler composite obtained is used in a rubber composition, the performance of the rubber-filler composite can be maximized, and low heat build-up and fatigue resistance of the rubber composition can be improved. Furthermore, proccessability can be improved.

### BRIEF DESCRIPTION OF THE DRAWINGS

FIG. 1 is a cross-sectional view showing one example of a dispersion treating chamber.

FIG. 2 is a cross-sectional view showing one example of a mixing chamber.

FIG. 3 is a cross-sectional view showing other example of a mixing chamber.

### DETAILED DESCRIPTION

Articles related to an embodiment of the invention will be explained in details as follows.

In the present invention, various inorganic fillers such as carbon black, silica, clay or zeolite can be used as the filler. Those fillers can be used alone or as mixtures of two or more thereof. Preferably, carbon black, silica or a mixture thereof is used. The silica includes wet silica, dry silica and colloidal silica.

A filler slurry comprises the filler dispersed in an aqueous solvent such as water. Such a filler slurry can be obtained by, for example, adding water to a filler and stirring the mixture with a stirring machine. The content of the filler in the filler slurry is preferably 5 to 20% by weight from the points of a crushing effect in a dispersion step of the filler and a mixing effect of the filler slurry with a latex in the subsequent mixing step with a field latex.

In the present invention, a field latex of a natural rubber is used as a rubber latex. The field latex is a rubber latex collected from a natural rubber tree by tapping, and a rubber concentration (DRC: Dry Rubber Content) is generally from 30 to 40% by weight. Such a field latex contains a non-rubber component such as protein. Therefore, in the present invention, the field latex is high-speed jetted at a flow rate of 500 m/sec or more to deproteinize.

A method for producing a rubber-filler composite according to one preferred embodiment of the present invention is described in detail below. The production method according to the embodiment includes:

1. a dispersion step of finely dispersing a filler slurry, and

2. a mixing step of mixing a field latex of a natural rubber with the finely dispersed filler slurry while high-speed jetting the field latex of a natural rubber.

In the dispersion step, a high-speed flow of a filler slurry having a flow rate of 300 m/sec or more is formed, and the high-speed flow is supplied to a dispersion treating chamber, thereby crushing the filler and finely dispersing the same in the slurry. Conventionally, fine dispersion treatment at such high speed has not been conducted at all to the rubber-filler composite particularly for use in tires, and it has not been considered that the fine dispersion treatment at such high speed gives practically advantageous effect on the tire performance. In other words, it has been required to uniformly disperse the filler in a rubber, but such high degree of fine dispersion has not been required. The present invention has found that treatment with a high-speed flow greatly exceeding the conventional level gives practically advantageous effect as a rubber-filler composite used in tires or the like.

The flow rate of the filler slurry is preferably from 300 to 700 m/sec, and more preferably from 500 to 700 m/sec. Regarding the lower limit of 300 m/sec, where the lower limit is less than this value, fine dispersion effect is poor, and improvement effect in low heat build-up, high fatigue resistance, proccessability and the like as a rubber composition is insufficient. On the other hand, the fine dispersion effect is preferable as a flow rate is high. However, a flow rate exceeding 700 m/sec is difficult to control with the current machines. Therefore, it is preferred that the upper limit is 700 m/sec or lower.

In the dispersion step, various dispersants such as anionic, cationic, nonionic or amphoteric dispersants can previously be added to the filler slurry. Specifically, examples of the dispersant used include a sodium salt of β-naphthalenesulfonic acid-formalin condensate, lauryltrimethylammonium chloride, polyoxyethylene distyrenated phenyl ether and laurylbetaine. Those can be used alone or as mixtures of two or more thereof.

In the dispersion step, in more detail, pressure energy of ultrahigh pressure is given to a filler slurry using a high pressure generator to form a high-speed flow having a flow rate of 300 m/sec or more. For example, pressure energy of ultrahigh pressure of from 45 to 245 MPa is given to accelerate to 300 to 700 m/sec.

The high-speed flow is supplied to a dispersion treating chamber, and crushing, dispersion and the like of a filler are conducted by the action of collision, cavitation, turbulent flow or the like in the chamber, thereby finely dispersing the filler slurry. In more detail, (A) a method of finely dispersing by cavitation or turbulent flow in jetting the high-speed flow in a chamber charged with fluid, (B) a method of crushing by branching the high-speed flow into two flows and countercolliding those in a chamber, (C) a method of crushing by collision by jetting the high-speed flow to a rigid body such as a spherical body, (D) a method of crushing by forming a high-speed flow by accelerating a filler slurry with plural nozzles, and jetting those high-speed flows in a chamber to collide and mix those, and the like are exemplified.

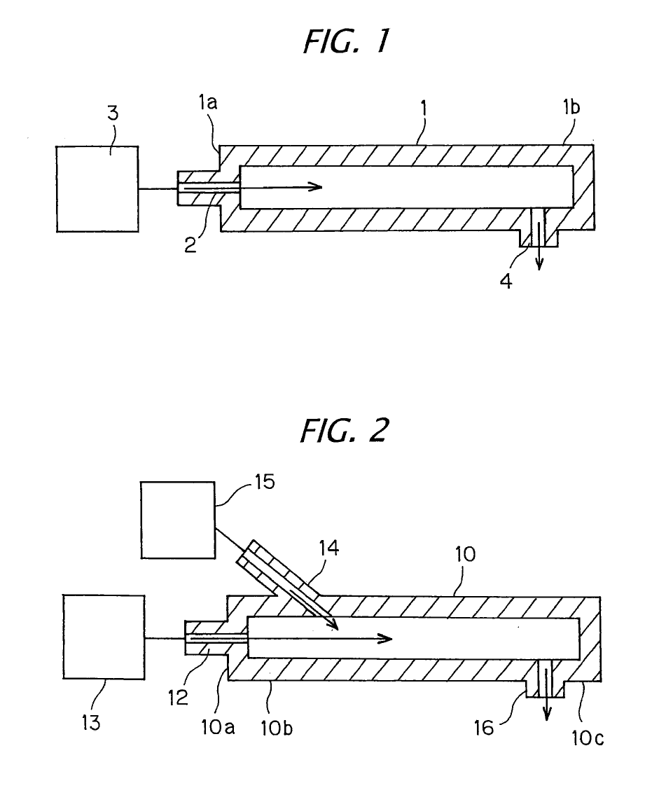

FIG. 1 shows a preferable one embodiment of a dispersion step, and a dispersion treating chamber (1) is cylindrical. A supply port (2) for supplying a filler slurry is provided on one end face (1a) in an axial direction of the dispersion treating chamber (1), and a high pressure generator (3) for supplying a filler slurry in the state of the above high-speed flow is connected to the supply port (2). A discharge port (4) of the filler slurry dispersion treated is provided on other end (1b) in an axial direction of the dispersion treating chamber (1).

In the dispersion step, a liquid such as water is previously charged in the dispersion treating chamber (1), and the filler slurry is jetted in the dispersion treating chamber (1) in a form of a high-speed flow having a flow rate of 300 m/sec or more from the supply port (2). The filler slurry jetted is crushed by cavitation or turbulent flow and finely dispersed in the dispersion treating chamber (1). The liquid charged at first in the dispersion treating chamber (1) is replaced with the filler slurry by jetting the filler slurry, and the inside of the dispersion treating chamber (1) is in a state of being filled with the filler slurry at stationary time. The filler slurry thus finely dispersed is discharged from the discharge port (4), and sent to the next mixing step.

In the mixing step, a field latex of a natural rubber is jetted in a mixing chamber in a form of a high-speed flow having a flow rate of 500 m/sec or more while supplying the finely dispersed filler slurry obtained above to the mixing chamber, thereby mixing the field latex and the filler slurry.

By jetting the field latex of a natural rubber in a form of a high-speed flow having a flow rate of 500 m/sec or more, protein in the field latex can be separated and removed from a rubber component by the action of collision, cavitation, turbulent flow or the like in the mixing chamber. Conventionally, jetting treatment at such high speed has not been conducted at all to a field latex, and practically advantageous effect as a rubber-filler composite used in tires or the like has first been found by the present invention.

The flow rate of the field latex is preferably from 500 to 700 m/sec, and more preferably from 600 to 700 m/sec. Regarding the lower limit of 500 m/sec, where the lower limit is less than this value, removal of protein is insufficient, and improvement effect in low heat build-up, high fatigue resistance or the like as a rubber composition is insufficient. On the other hand, the protein removal effect is preferable as a flow rate is high. However, a flow rate exceeding 700 m/sec is difficult to control with the current machines. Therefore, it is preferred that the upper limit is 700 m/sec or lower.

In the mixing step, in more detail, pressure energy of ultrahigh pressure is given to a field latex using a high pressure generator to form a high-speed flow having a flow rate of 500 m/sec or more. For example, pressure energy of ultrahigh pressure of from 125 to 245 MPa is given to accelerate to 500 to 700 m/sec.

In more detail, examples of the mixing step include (E) a method of supplying a filler slurry from its downstream side while jetting a high-speed flow of a field latex in a mixing chamber, and mixing those by cavitation or turbulent flow due to the high-speed flow, and (F) a method of jetting a field latex and a filler slurry in a form of a high-speed flow in a mixing chamber, respectively, and colliding and mixing those.

FIG. 2 shows a preferable one embodiment of the mixing step, and a mixing chamber (10) is cylindrical. A first supply port (12) for supplying a field latex is provided on one end face (10a) in an axial direction of the mixing chamber (10), and a high pressure generator (13) for supplying the field latex in a state of the high-speed flow is connected to the first supply port (12). A second supply port (14) for supplying a filler slurry is provided at a downstream side of the first supply port (10) in one end (10b) in an axial direction of the mixing chamber (10), and a slurry supply tank (15) for supplying the filler slurry is connected to the second supply port (14). A discharge port (16) for discharging a mixed fluid is provided on other end (10c) in an axial direction of the mixing chamber (10).

In the mixing step, the field latex is jetted in the mixing chamber (10) in a form of a high-speed flow having a flow rate of 500 m/sec or more from the first supply port (12). The filler slurry is drawn in the mixing chamber (10) through the second supply port (14) from the slurry supply tank (15) by negative pressure due to flow of the jetted field latex in the mixing chamber (10). A non-rubber component such as protein in the field latex is separated and removed from a rubber component by cavitation or turbulent flow by the field latex in a form of a high-speed flow in the mixing chamber (10), and at the same time, the field latex and the filler slurry are mixed, thereby the filler is finely dispersed in the rubber component. The thus obtained mixed liquid of the filler slurry and the field latex is discharged from a discharge port (16).

The mixing ratio of the filler slurry and the field latex is preferably in a range such that the filler is from 20 to 80 parts by weight per 100 parts by weight of the rubber component.

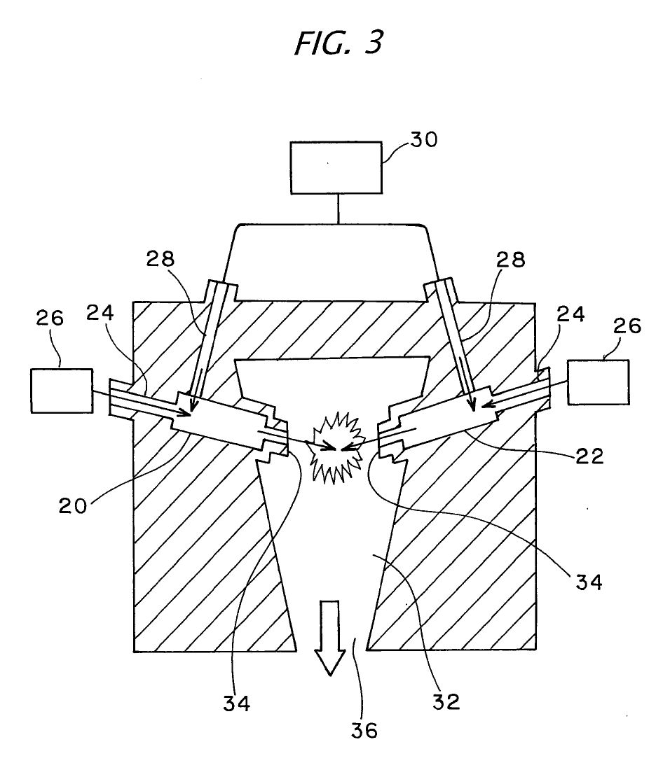

FIG. 3 shows other embodiment of the mixing step. This embodiment has two right and left mixing chambers (20) and (22), each having the same constitution as shown in FIG. 2, and is constituted such that high-speed flows jetted from those two chambers are collided with each other to mix those.

In detail, a first mixing chamber (20) and a second mixing chamber (22) are provided, a first supply port (24) for supplying a field latex is provided to each of the mixing chambers (20) and (22) on one end face in an axial direction thereof, respectively, and a high pressure generator (26) for supplying a field latex in the high-speed flow state is connected to each first supply port (24). Furthermore, a second supply port (28) for supplying a filler slurry is provided on each mixing chamber at a downstream side of the first supply port (24), respectively, and a common slurry supply tank (30) supplying a filler slurry is connected to the two second supply ports (28). Other end in an axial direction of each of the mixing chambers (20) and (22) projects in a collision tank (32), an jetting port (34) for jetting a mixed fluid is provided on the thus projected other ends in an axial direction of the mixing chambers (20) and (22), respectively, and high-speed fluids jetted from those jetting ports (34) are collided in the collision tank (32). A discharge port (36) for discharging a mixed fluid by collision is provided on a lower end of the collision tank (32).

In the mixing step, the field latex is jetted in each of the mixing chambers (20) and (22) in a form of a high-speed flow having a flow rate of 500 m/sec or more from the first supply port (24). By this, the filler slurry is forcedly drawn in the mixing chambers (20) and (22) through the second supply port (28) from the slurry supply tank (30), similar to the case of FIG. 2, and deproteinization of the field latex and mixing of the field latex and the filler slurry are performed. The fluid thus mixed is jetted from the jetting port (34) of the mixing chambers (20) and (22), the jetted flows are collided in the collision tank (32), thereby further uniformly being dispersed and mixed, and the uniformly dispersed and mixed fluid is discharged from the lower discharge port (36).

The thus obtained mixed liquid of the field latex and the filler slurry is passed through coagulation and drying steps (not shown) according to the conventional methods, thereby a solid rubber-filler composite is obtained.

The rubber-filler composite obtained can be used as a masterbatch in preparing a rubber composition for vulcanization. In such a rubber composition, a rubber component may be only a rubber component added as a rubber-filler composite, but other rubber may be compounded together with the rubber-filler composite. Other compounding agents include oils, age resisters, zinc white, stearic acid, softeners, vulcanizing agents and vulcanization accelerators, but are not particularly limited.

The other rubber is not particularly limited, and examples thereof include natural rubber, isoprene rubber, butadiene rubber, styrene-butadiene rubber, butyl rubber, halogenated butyl rubber, ethylene-propylene rubber, nitrile rubber, and various rubber polymers such as derivatives of those rubbers.

A rubber composition having compounded therewith the rubber-filler composite can be deproteinized by high-speed jetting a field latex at the time of mixing with a filler slurry. Therefore, a concentration step of the field latex can be omitted, and low heat build-up, high fatigue resistance and heat aging resistance equal to those of a concentrated natural rubber latex can be obtained. Furthermore, by using a previously finely pulverized filler slurry, the performance of the filler can be maximized, and low heat build-up and high fatigue resistance are further improved. Additionally, the proccessability can be improved. Therefore, the rubber composition can preferably be used in various rubber compositions including rubber compositions for tires, such as tread rubber, side wall rubbers.

### EXAMPLES

The present invention is described in more detail by reference to the following Examples, but the invention is not construed as being limited thereto.

### Example 1 to 4

### Preparation of Masterbatch

Each masterbatch of Examples 1 to 4 and Comparative Examples 1 to 4 was prepared as follows.

### Example 1

In a dispersion step, water was added to carbon black (MA600, a product of Mitsubishi Chemical Corporation) in an amount so as to be 10% by weight. The resulting mixture was stirred with a stirring machine (stirring speed: 50 m/sec), and then dispersion treated in a dispersion treating chamber (inner diameter: about 20 mm, length: about 25 cm, nozzle diameter of supply port (2): 0.15 mm) shown in FIG. 1. The dispersion treatment was conducted by jetting a slurry after stirring as above in the dispersion treating chamber at a flow rate of 700 m/sec (pressure of high pressure generator: 245 MPa), and this dispersion treatment was passed five times.

In a subsequent mixing step, a mixing chamber (inner diameter: 3.2 mm, length: 50 cm, nozzle diameter of first supply port (12): 0.15 mm) as shown in FIG. 2 was used, 200 parts by weight of a field latex of a natural rubber (NR LATEX, a product of Golden Hope, rubber concentration DRC: 30% by weight) were jetted from the first sully port (12) at a flow rate of 500 m/sec (pressure of high pressure generator: 125 MPa), and at the same time, 300 parts by weight of the carbon black slurry dispersed as above were supplied from a second supply port (14). After thus mixing, a coagulate was obtained. The coagulate obtained was dried with a vacuum dryer until becoming a water content (measured at 100° C.) of 1% by weight, thereby preparing a masterbatch (containing 50 parts by weight of carbon black per 100 parts by weight of the natural rubber).

### Example 2

A masterbatch was prepared in the same manner as in Example 1, except that a flow rate of the field latex in the mixing step is set to 600 m/sec (pressure of high pressure generator: 180 MPa).

### Example 3

A masterbatch was prepared in the same manner as in Example 1, except that a flow rate of the field latex in the mixing step is set to 700 m/sec (pressure of high pressure generator: 245 MPa).

### Example 4

A masterbatch was prepared in the same manner as in Example 3, except that a dispersant (DEMOL NL, a product of Kao Corporation, sodium salt of β-naphthalenesulfonic acid-formalin condensate: anionic) together with water is added to carbon black in an amount so as to be 0.3% by weight to prepare a carbon black slurry, and the subsequent dispersion step and mixing step are the same as in Example 3.

### Comparative Example 1

A masterbatch was prepared in the same manner as in Example 1, except that 200 parts by weight of a field latex of a natural rubber and 300 parts by weight of a carbon black slurry are stirred with a stirring machine (stirring speed: 50 m/sec) in place of conducting the mixing by the mixing chamber.

### Comparative Example 2

A masterbatch was prepared in the same manner as in Example 1, except that a flow rate of the field latex in the mixing step is set to 244 m/sec (pressure of high pressure generator: 30 MPa).

### Comparative Example 3

A masterbatch was prepared in the same manner as in Example 1, except that 100 parts by weight of a latex obtained by previously concentration treating (10,000 rpm, 30 minutes) the field latex with a centrifugal separator are used in place of directly using the field latex in the mixing step.

### Comparative Example 4

A masterbatch was prepared in the same manner as in Example 1, except that 100 parts by weight of a concentrated natural rubber latex (NR LATEX, a product of Regitex Co., Ltd., rubber concentration DRC: 60% by weight) are used in place of using the field latex in the mixing step.

Evaluation of Masterbatch The content of protein in each masterbatch was measured. The content of protein was measured by measuring total nitrogen amount contained in a rubber component of a masterbatch by Kjeldahl method according to JIS K0102. In detail, concentrated sulfuric acid was added to a masterbatch. The resulting mixture was heated to induce decomposition and redox reaction, thereby changing nitrogen contained in the protein to NH₃, and nitrogen amount was calculated by measuring with titration.

A rubber composition was prepared using each masterbatch obtained above. The formulation of the rubber composition was the masterbatch: 150 parts by weight (rubber component: 100 parts by weight), stearic acid (a product of Kao Corporation, LUNAC S-25): 1 part by weight, age resister (a product of Monsanto, 6PPD): 1 part by weight, zinc white (a product of Mitsui Mining and Smelting Co., Ltd., Zinc White No. 1): 3 parts by weight, wax (a product of Nippon Seiro Co., Ltd., OZOACE 0355): 1 part by weight, sulfur (a product of Tsurumi Kagaku Kogyo K.K., oil-treatment 150 meshes): 2 parts by weight, and vulcanization accelerator (a product of Sanshin Chemical Industry Co., Ltd., CBS): 1 part by weight. Dispersibility, fatigue property, heat build-up, proccessability and heat aging resistance of each rubber composition obtained were evaluated, and the results obtained are shown in Table 1. Each evaluation method is as follows. The vulcanization conditions of each sample were 150° C. and 30 minutes.

Dispersibility: Measured according to ASTM D2663-69, method B

Fatigue property: Measured according to JIS K6270. Indicated by index as Comparative Example 1 being 100. Larger index means good fatigue resistance (crack resistance).

Heat build-up: Heat generation temperature is measured according to JIS K6265. Indicated by index as Comparative Example 1 being 100. Smaller index means low heat generation temperature and good low heat build-up.

Proccessability: Mooney viscosity is measured according to JIS K6300-1. Indicated by index as Comparative Example 1 being 100. Smaller index means low Mooney viscosity and good proccessability.

Heat aging resistance: After heat aging at 90° C. for 96 hours, retention of tensile strength (TB) is measured according to JIS K6251. Indicated by index as Comparative Example 1 being 100. Larger index means good heat aging resistance.

TABLE 1

| | | Comparative | Comparative | Exam- | Exam- | Exam- | | Comparative | Comparative |
|---|---|---|---|---|---|---|---|---|---|
| | | Example 1 | Example 2 | ple 1 | ple 2 | ple 3 | Example 4 | Example 3 | Example 4 |
| Formulation | Natural rubber field latex | 200 | 200 | 200 | 200 | 200 | 200 | | |
| (parts by | Centrifugal separation | | | | | | | 100 | |
| weight) | concentrate latex | | | | | | | | |
| | Concentrated natural | | | | | | | | 100 |
| | rubber latex | | | | | | | | |
| | Carbon black slurry | 300 | 300 | 300 | 300 | 300 | 300 | 300 | 300 |
| | Dispersant (wt %) | | | | | | 0.3 | | |

| | | | | | | | | |
|---|---|---|---|---|---|---|---|---|
| Carbon black compounding | 50 | 50 | 50 | 50 | 50 | 50 | 50 | 50 |
| amount (phr) | | | | | | | | |
| Jetting speed of latex (m/s) | 0 | 244 | 500 | 600 | 700 | 700 | 700 | 700 |
| Dispersibility (%) | 97.6 | 97.8 | 98.0 | 98.0 | 98.1 | 98.2 | 98.0 | 98.2 |
| Fatigue property | 100 | 105 | 114 | 117 | 119 | 120 | 113 | 121 |
| Heat build-up | 100 | 97 | 88 | 85 | 82 | 80 | 92 | 79 |
| Processability | 100 | 82 | 81 | 80 | 80 | 79 | 80 | 80 |
| Heat aging resistance | 100 | 100 | 104 | 104 | 105 | 105 | 104 | 108 |
| Number of processing step | 2 | 2 | 2 | 2 | 2 | 2 | 3 | 3 |
| Content of protein (wt %) | 0.75 | 0.52 | 0.36 | 0.32 | 0.27 | 0.26 | 0.27 | 0.25 |

As shown in Table 1, in the rubber compositions using carbon black/natural rubber composites of the Examples, the field latex was deproteinized by high-speed jetting. As a result, despite the rubber compositions using a field latex, low heat build-up, fatigue resistance, proccessability and heat aging resistance substantially equal to those of Comparative Example 4 using a concentrated natural rubber latex were obtained, and great improvements in those performances were recognized as compared with Comparative Example 1 in which a field latex was not high-speed jetted. In Comparative Example 2, a flow rate in the mixing step of the field latex is low, and sufficient effect according to the present invention was not obtained.

Furthermore, in the case that the field latex was previously concentrated by centrifugal separation as in Comparative Example 3, improvement in the above performances was recognized by deproteinization, but a pre-treatment by centrifugal separation was necessary, and the number of processing step required additional one step. Comparative Example 4 is an embodiment using a concentrated natural rubber latex. Therefore, the number of processing step requires additional one step when the concentration step is considered one step.

### Example 5 and 6

### Preparation of Masterbatch

Each masterbatch of Examples 5 and 6 and Comparative Examples 5 and 6 was prepared as follows.

### Example 5

A masterbatch was prepared in the same manner as in Example 1, except that Carbon Black #2700, a product of Mitsubishi Chemical Corporation, is used as carbon black, and a mixing chamber (inner diameter of each chamber: about 20 mm, length: about 10 cm, nozzle diameter of first supply port (24): 0.15 mm) shown in FIG. 3 is used in the mixing step.

### Example 6

A masterbatch was prepared in the same manner as in Example 5, except that a flow rate of the field latex in the mixing step is set to 700 m/sec (pressure of high pressure generator: 245 MPa).

### Comparative Example 5

A masterbatch was prepared in the same manner as in Example 5, except that 200 parts by weight of a field latex of a natural rubber and 300 parts by weight of a carbon black slurry are stirred with a stirring machine (stirring speed: 50 m/sec) in place of conducting the mixing by the mixing chamber.

### Comparative Example 6

A masterbatch was prepared in the same manner as in Example 5, except that a flow rate of the field latex in the mixing step is set to 244 m/sec (pressure of high pressure generator: 30 MPa).

### Evaluation of Masterbatch

The content of protein in each masterbatch was measured. Furthermore, each rubber composition was prepared using each masterbatch. The formulation of the rubber composition is the same as in Example 1. Dispersibility, fatigue property, heat build-up, proccessability and heat aging resistance of each rubber composition obtained were evaluated, and the results obtained are shown in Table 2. Each evaluation method is the same as in Table 1 above. However, indexes of fatigue property, heat build-up, proccessability and heat aging resistance were indicated as Comparative Example 5 being 100.

TABLE 2

| | | Comparative | Comparative | | |
|---|---|---|---|---|---|
| | | Example 5 | Example 6 | Example 5 | Example 6 |
| Formulation | Natural rubber field latex | 200 | 200 | 200 | 200 |
| (parts by weight) | Carbon black slurry | 300 | 300 | 300 | 300 |

| | | | | |
|---|---|---|---|---|
| Carbon black compounding amount (phr) | 50 | 50 | 50 | 50 |
| Jetting speed of latex (m/s) | 0 | 244 | 500 | 700 |
| Dispersibility (%) | 96.4 | 97.0 | 97.9 | 98.0 |
| Fatigue property | 100 | 103 | 112 | 117 |
| Heat build-up | 100 | 98 | 87 | 81 |
| Processability | 100 | 84 | 79 | 75 |
| Heat aging resistance | 100 | 100 | 104 | 104 |
| Number of processing step | 2 | 2 | 2 | 2 |
| Content of protein (wt %) | 0.75 | 0.53 | 0.35 | 0.27 |

What is claimed is:

1. A method for producing a rubber-filler composite, comprising jetting a field latex of a natural rubber in a form of a high-speed flow having a flow rate of 500 m/sec or more into a mixing chamber while supplying a filler slurry containing a filler to the mixing chamber, thereby separating and removing protein in the field latex from a rubber component and at the same time, mixing the field latex and the filler slurry.

2. The method for producing a rubber-filler composite as claimed in claim 1, wherein the filler is finely dispersed in the slurry by supplying the filler slurry at a flow rate of 300 m/sec or more to a dispersion treating chamber before mixing the filler slurry with the field latex.

3. The method for producing a rubber-filler composite as claimed in claim 1, wherein the filler is carbon black.

4. The method for producing a rubber-filler composite as claimed in claim 1, wherein while the high-speed flow of the field latex is jetted into the mixing chamber, the filler slurry is supplied into the mixing chamber from its downstream side, and the field latex and the filler slurry are mixed by cavitation and/or turbulent flow due to the high-speed flow.

5. A rubber-filler composite produced by the method as claimed in claim 1.

6. A rubber composition using the rubber-filler composite as claimed in claim 5
